(19) United States
(12) Patent Application Publication
(10) Pub. No.: US 2005/0124295 A1
(43) Pub. Date: Jun. 9, 2005

(54) Multi-frequency wireless receiver for computer peripheral device

(75) Inventors: Bo-Xun Xian, Taipei (TW); Ren-Kai Zheng, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP, TAIPEI (TW)

(21) Appl. No.: 10/725,366

(22) Filed: Dec. 3, 2003

(51) Int. Cl. H04B 1/00

(52) U.S. Cl. 455/41.3

(57) ABSTRACT

A multiple frequency wireless receiver for connecting computer peripheral devices with a host computer via an interface, includes a single oscillator for generating an oscillator signal; a mixer coupled to the receiving unit for mixing at least two signals having different frequencies with the oscillator signal in order to obtain at least two different mixed signals, at least two filters tuned to different frequencies for respectively passing a respective one of the two different mixed signals to a mixed-signal processing unit for demodulation and transformation into commands to be sent to the host computer via the interface.

### BACKGROUND OF THE INVENTION

1. Field of the Invention

The present invention relates to a wireless receiver for computer peripheral devices, such as a computer mouse, keyboard, trackball, etc., and in particular, to an integral receiver which can receive multiple frequencies.

2. Description of the Prior Art

Wireless computer peripheral devices, such as a computer mouse, keyboard, trackball, game controller, etc., are becoming increasingly popular. As a result, it has become necessary to provide for multiple frequencies, to enable different wireless peripherals to be connected to the same computer system.

A bundled product, such as a wireless mouse plus a wireless keyboard, for example, uses a receiver with two different frequencies to receive both frequencies in an integral device. Referring to FIG. 1, the receiver mixes the two frequencies using individual oscillators 11a and 11b and then uses identical filters to process the mixed signals for demodulation. After being filtered and demodulated separately, the MCU can further process and transform each signal to a corresponding signal for output via a PS2 and USB/PS2 interface. Because both of the oscillators have a high frequency, any attempt to combine both oscillators into a single device will likely result in interference between the signals.

In order to solve the problem of interference, the usual practice is to isolate the two oscillators, or broaden the distance therebetween. However, the solutions mentioned above are not suitable for use in miniature wireless receivers, which are extremely popular nowadays.

Another way to solve the interference problem is to reduce the amplitude of the two oscillators. Unfortunately, this will also decrease the sensitivity for receiving a wireless signal.

### SUMMARY OF THE INVENTION

It is an objective of the present invention to provide an integral wireless receiver which can receive at least two frequencies.

It is another object of the present invention to provide a miniature wireless receiver capable of receiving at least two frequencies, and yet that occupies less space in a limited working surface, such as a desk.

These objectives are accomplished, in accordance with the principles of a preferred embodiment of the invention, by providing a receiver capable of receiving two frequencies, in which the conventional dual oscillators and identical filters and demodulators are replaced by a single oscillator arranged to output a single oscillating signal to be mixed with the at least two frequencies, and two different filters with corresponding demodulators for processing the resulting mixed signals of different frequency. By using a single oscillator and processing the resulting mixed signals using different filters and demodulators, the problem of oscillator interference is eliminated and the size of the receiver can be minimized.

### BRIEF DESCRIPTION OF THE DRAWINGS

FIG. 1 is a block diagram according to a prior art.

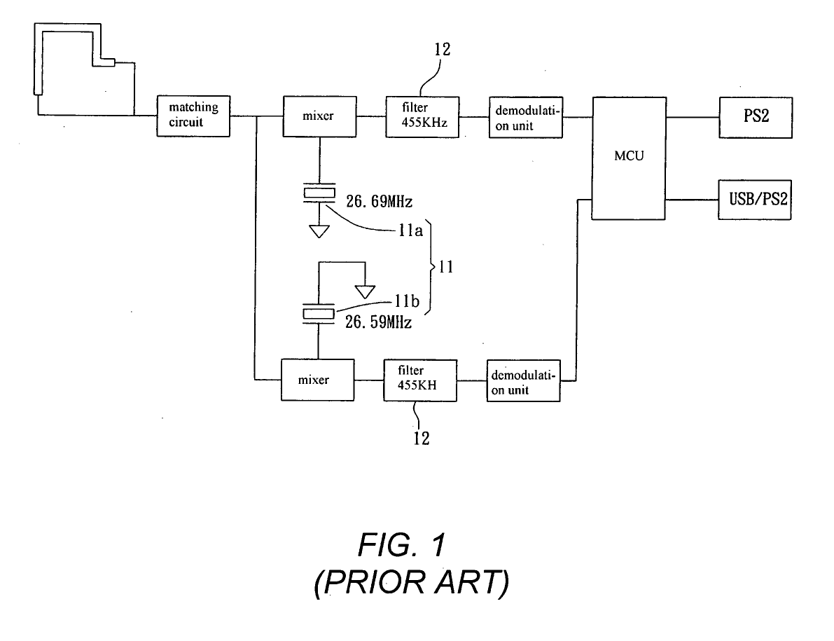

FIG. 2 is a block diagram according to the present invention.

FIG. 3 is circuit diagram according to FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

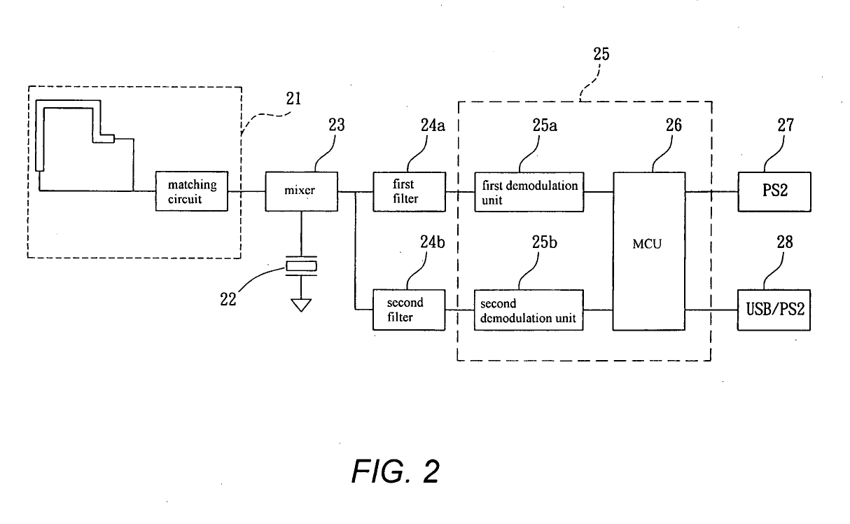

FIG. 2 illustrates, by way of example, a two-frequency receiver. The principles of the invention can also be applied to receivers capable of receiving more than two frequencies. In the illustrated example, the wireless receiver receives a first signal and a second signal by means of a receiving unit 21, an oscillator 22, a mixer 23, a first filter 24a, a second filter 24b, and a mixed-signal processing unit 25, which further has a first demodulation unit 25a, a second demodulation unit 25b, and a MCU (micro control unit) 26.

The receiving unit 21 can receive the first signal and the second signal, and the mixer 23 will mix a single oscillating signal from oscillator 22, and retrieve a first mixed signal and a second mixed signal. The result is two mixed signals at different frequencies. The first filter 24a and the second filter 24b therefore must be tuned to different frequencies, i.e., must have different, non-overlapping passbands, in order to respectively filter the first and second mixed signals. In addition, the first demodulation unit 25a and the second demodulation unit 25b can further demodulate the filtered first and second mixed signals, and send the demodulated signals to the MCU 26 to be processed and transformed into signals having specifications corresponding to those of the first or second interfaces.

In practical use, by way of example and not limitation, the wireless receiver can receive a first signal coming from a mouse, and a second signal coming from a keyboard. The receiver processes and sends the signals to a computer via interfaces 27 and 28 (in the PS2 specification, the mouse command is sent to the computer from interface 27, and the keyboard command is sent to the computer from the interface 28), or via interface 28 (in USB specification, mouse and keyboard commands can be sent only from interface 28). The oscillator 22 generates a frequency at 26.59 MHz, the first filter 24a is set at 455 KHz, and the second filter 24b is set at 505 KHz. Assuming that the first signal is 27.045 MHz, the second signal is 27.095.

When the receiving unit 21 receives the first signal at 27.045 MHz, the mixer 23 will mix an oscillating signal at 26.59 MHz from oscillator 22, and retrieve a first mixed signal at 455 KHz. The first filter 24a can filter noise, allowing only the first mixed signal at 455 KHZ to pass therethrough. The first demodulation 25a can then further demodulate the filtered first mixed signal, sending it to the MCU 26 to be processed and transformed into the specification corresponding to the first interface 27 (PS2) or second interface (USB) so as to deliver a first command to the computer.

When the receiving unit 21 receives the second signal at 27.095 MHz, the mixer 23 will mix an oscillating signal at 26.59 MHz from oscillator 22, and retrieve a second mixed signal at 505 KHz. The second filter 24b can filter noise, allowing only the second mixed signal at 505 KHz to pass therethrough. The second demodulation 25b can then further demodulate the filtered second mixed signal, sending it to the MCU 26 to be processed and transformed into the specification corresponding to the second interface 28 (PS2) or second interface (USB) so as to deliver a second command to computer.

If a third or additional wireless signals, for example from a joystick, are to be received by the wireless receiver, a third or additional filters having different frequencies and a third or additional demodulation units may be added within the receiver.

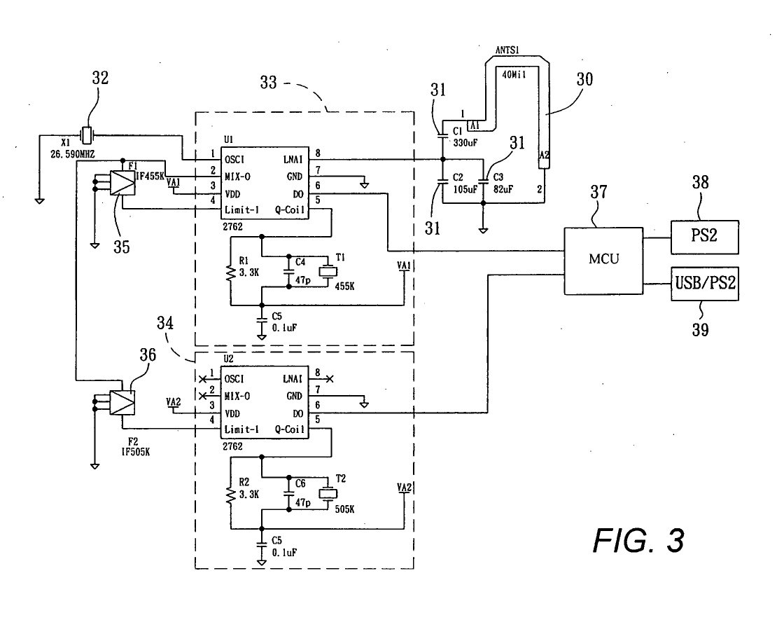

FIG. 3 is a circuit diagram of a practical embodiment of the present invention illustrated in FIG. 2. The receiver comprises an antenna 30, an oscillator 32, first and second mixer/demodulation units 33 and 34, a first filter 35, a second filter 36, an MCU 37, a first interface 38 and a second interface 39.

When the receiving unit 30 receives the first signal (wireless mouse) at 27.045 MHz, the mixer/demodulation unit 33 will mix an oscillating signal at 26.59 MHz from oscillator 32, and retrieve a first mixed signal at 455 KHz. The first filter 35 can filter noise, allowing only the first mixed signal at 455 KHZ to pass therethrough. The mixer/demodulation unit 33 can further demodulate the filtered first mixed signal, sending it to the MCU 37 to be processed and transformed into the specification corresponding to the first interface 27 (PS2) or second interface (USB) so as to deliver a first command to the host computer (not shown).

When the receiving unit 30 receives the second signal (wireless keyboard) at 27.095 MHz, the mixer/demodulation unit 34 will mix an oscillating signal at 26.59 MHz from oscillator 32, and retrieve a first mixed signal at 505 KHz. The second filter 36 can filter noise, allowing only the second mixed signal at 505 KHZ to pass therethrough. The mixer/demodulation unit 34 can further demodulate the filtered second mixed signal, sending it to the MCU 37 to be processed and transformed into the specification corresponding to the second interface 28 (PS2) or second interface (USB) so as to deliver a second command to computer.

According to the present invention, the present invention solves not only the problem of interference, but also keeps a good sensitivity for receiving wireless signals.

While the description above refers to particular embodiments of the present invention, it will be understood that many modifications may be made without departing from the spirit thereof. The accompanying claims are intended to cover such modifications as would fall within the true scope and spirit of the present invention.

1. A multiple frequency wireless receiver for computer peripheral devices, connecting to a computer via an interface, comprising:
a receiving unit for receiving at least two frequencies;
an oscillator for generating a single oscillating signal;
a mixer coupled to the receiving unit, and for mixing the at least two mixed signals with the single oscillating signal to obtain two mixed signals of different frequency;
at least two filters coupled to the mixer and tuned to different frequencies to respectively allow one of the two mixed signals of different frequency to pass therethrough, and to send the respective filtered mixed signals to a mixed-signal processing unit;
wherein the mixed-signal processing unit further processes and transforms the mixed signals into at least two commands for sending to the computer via the interface.

2. The wireless receiver as claimed in claim 1, wherein the mixed-signal processing unit further has at least two demodulation units connected to receive outputs of the respective filters, and a micro control unit for transforming the mixed signals into said at least two commands.

3. The wireless receiver as claimed in claim 1, wherein the interface includes at least a pair of PS2 ports for respectively sending at least two commands.

4. The wireless receiver as claimed in claim 1, wherein the interface is a USB port for sending at least two commands.

5. The wireless receiver as claimed in claim 1, wherein the first frequency is 27.045 MHz, the second frequency is 27.095 MHz, the oscillator generates a frequency of 26.59 MHz, the first filter is tuned to 455 KHz, and the second filter is tuned to 505 KHz.

6. The wireless receiver as claimed in claim 1, wherein the receiver is arranged to receive wireless command signals from a wireless mouse and a wireless keyboard.
